(19) United States
(12) Patent Application Publication
(10) Pub. No.: US 2006/0252659 A1
(43) Pub. Date: Nov. 9, 2006

(54) Lubricating oil for dynamic fluid-pressure bearing, dynamic-fluid-pressure bearing, motor, and information recording/reproducing apparatus

(76) Inventors: Shinji Kinoshita, Chiba-ken (JP); Hiromitsu Goto, Chiba-ken (JP); Atsushi Ota, Chiba-ken (JP); Shigeo Mori, Kyoto (JP); Yoshihisa Okamoto, Tokyo (JP)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/561,805

(22) PCT Filed: Jun. 25, 2004
(86) PCT No.: PCT/JP04/09389

§ 371 Date: May 24, 2006

(30) Foreign Application Priority Data
Jun. 27, 2003 (JP) 2003-185419

(51) Int. Cl. C10M 137/04; F16C 32/06

(52) U.S. Cl. 508/433; 508/322; 384/100

(57) ABSTRACT

This lubricant for a fluid dynamic bearing has a base oil containing a phosphate triester represented by a general formula (I) 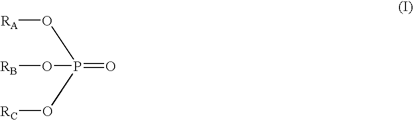
(wherein, R_{A}, R_{B} and R_{C} respectively represent alkyl groups), wherein in the base oil, a phosphate triester in which the three alkyl groups in the general formula (I) are saturated hydrocarbon groups and number of carbon atoms of one of the three saturated hydrocarbon groups differs from number of carbon atoms of the other two saturated hydrocarbon groups is contained as a primary base oil.

### TECHNICAL FIELD

The present invention relates to a lubricant for a fluid dynamic bearing that is filled into a gap between a shaft body and a shaft support section that supports a shaft body while allowing to rotate freely, a fluid dynamic bearing in which the lubricant is used, a motor having this fluid dynamic bearing, and an information recording and retrieval device having this motor.

The present application claims priority on Japanese Patent Application No. 2003-185419, filed on Jun. 27, 2003, the content of which is incorporated herein by reference.

### BACKGROUND ART

In recent years, motors capable of rotating magnetic disks, optical disk, or other information recording media at high speeds have come to be provided in hard disk drives (HDD) installed in desktop personal computers, portable notebook personal computers, and other terminal devices. These motors has fluid dynamic bearings since the motors used in the aforementioned applications are required to improve rotating speed and rotational accuracy of the information recording medium.

For example, as is disclosed in Japanese Unexamined Patent Application, First Publication No. 2001-139971 (page 4, FIGS. 1-3), this fluid dynamic bearing has a fluid in a form of a lubricant filled into a gap between a shaft body and a sleeve (shaft body support section), and the shaft body and the sleeve are mutually rotated while there is no contact between them.

The aforementioned lubricant is composed of a base lubricating fluid (base oil) along with additives such as an antioxidant, a rust preventive agent, or a friction preventive agent as necessary. Here, the base lubricating fluid preferably has a low viscosity in order to reduce current loss generated during driving of the information recording medium, as well as low temperature dependency in the viscosity in order to improve the rotational accuracy of the information recording medium.

The antioxidants, the rust preventive agents, and the friction preventive agents all prevent deterioration of the shaft body and the sleeve that compose the fluid dynamic bearing. In particular, the friction preventive agents are important elements for preventing friction and wear of the shaft body and the sleeve. This is because the shaft body and the sleeve make contact when the information recording medium is stopped, and friction and wear occur between the shaft body and the sleeve when starting the information recording medium.

In addition, since the aforementioned lubricant slowly evaporates as a result of long-term use, when it evaporates to an amount at which dynamic pressure is no longer able to be generated, the fluid dynamic bearing loses its function. Consequently, the lubricant preferably has a low amount of evaporation.

On the basis of the above, mineral oil-based lubricants having low viscosity and comparatively favorable characteristics in high oxidation resistance, high boundary lubrication, low surface mobility, low viscosity temperature dependency, and a low amount of evaporation have been used as lubricants for fluid dynamic bearings of the prior art. In addition, although ester phosphate-based lubricants have been proposed, they are not yet used practically.

Furthermore, there has been a growing demand in recent years for motors and fluid dynamic bearings to become increasingly compact and thin so that HDDs can be installed in cell phones, digital cameras, and other compact information home appliances.

However, it is necessary to reduce the gap between the shaft body and the sleeve when attempting to reduce size and thickness of the fluid dynamic bearing and the motor while considering ensuring rigidity of the shaft body and the sleeve. Thus, since an absolute volume of the lubricant filled into this gap decreases, the lubricant is required to have an even lower amount of evaporation. In addition, when attempting to reduce the size and the thickness of the motor, since the torque generated by the motor decreases, it is necessary to further reduce the viscosity of the lubricant. Moreover, the lubricant is also required to reduce the viscosity temperature dependency in order to improve the rotational accuracy of the information recording medium.

However, motors equipped with fluid dynamic bearings also have a problem of rotation lockup resulting from depletion of the oil film on a bearing surface caused by starting and stopping of the motor. Here, the rotation lockup refers to a state in which the shaft body and the sleeve are mutually unable to move, and the fluid dynamic bearing cannot be used in this state.

In the prior art, in order to solve this problem, while either the shaft body or the sleeve was formed from a hard metal material, the other was formed from a soft metal material, for preventing a phenomenon of galling caused by the depletion of the oil film. Here, the galling refers to a phenomenon in which, in the case the shaft body and the sleeve are formed from the same type of metal material and a surface of the shaft body and an inner wall surface of the sleeve have been finished to smooth surfaces, the shaft body surface and the inner wall surface of the sleeve are adsorbed during contact between these surfaces, thereby making it difficult for the shaft body to move relative to the sleeve. This galling is one of factors that causes the rotation lockup.

However, in the case of attempting to reduce the size and the thickness of the motor, although it is necessary to reduce the gap between the shaft body and the sleeve as was previously stated, since the shaft body and the sleeve composed of different types of metal materials are more susceptible to contact when this gap is reduced, the wear between the shaft body and the sleeve increases, and the problem of the rotation lockup occurred based on a presence of fine particles generated by this wear.

The formation of the shaft body and the sleeve from the same type of metal material, and the preliminary application of a surface coating onto the surface of the shaft body and the inner wall surface of the sleeve have been considered as a method for eliminating the problem of the rotation lockup. However, since the size of the gap is extremely narrow at only several micrometers, it becomes difficult to control gap thickness if the surface coating is thick. Consequently, this method cannot be applied to the fluid dynamic bearings.

### DISCLOSURE OF THE INVENTION

In consideration of the aforementioned circumstances, this invention provides a lubricant for a fluid dynamic bearing, a fluid dynamic bearing, a motor, and an information recording and retrieval device that are capable of improving reliability by prolonging service life and improving rotational accuracy as well as reducing a current consumption.

This invention proposes the following means for solving the aforementioned problems.

A lubricant for a fluid dynamic bearing has a base oil containing a phosphate triester represented by a general formula (I) 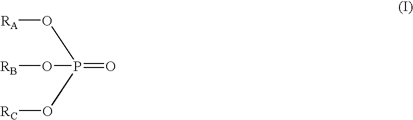
(wherein, R_{A}, R_{B} and R_{C} respectively represent alkyl groups), wherein in the base oil, a phosphate triester in which the three alkyl groups in the general formula (I) are saturated hydrocarbon groups and the number of carbon atoms of one of the three saturated hydrocarbon groups differs from the number of carbon atoms of the other two saturated hydrocarbon groups is contained as a primary base oil.

According to the lubricant for the fluid dynamic bearing in this invention, a tradeoff relationship between an amount of evaporation and viscosity of the lubricant can be diminished in comparison with conventional lubricants for fluid dynamic bearings having, as their base oils, phosphate triesters having saturated hydrocarbon groups in which numbers of carbon atoms are all the same (to also be referred to as conventional lubricants). Thus, a lubricant can be provided having a lower amount of evaporation, lower viscosity, and lower viscosity temperature dependency.

In the lubricant for the fluid dynamic bearing in the present invention, the primary base oil may have at least one saturated hydrocarbon group having 8 to 9 carbon atoms, and at least one saturated hydrocarbon group having 6 to 7 carbon atoms.

In the lubricant for the fluid dynamic bearing in the present invention, the saturated hydrocarbon group having 8 to 9 carbon atoms may be any one or more of 2-ethyl-1-hexyl group, 1-octyl group, 3,5,5-trimethyl-1-hexyl group, isononyl group, and 1-nonyl group.

In the lubricant for the fluid dynamic bearing in the present invention, the saturated hydrocarbon group having 6 to 7 carbon atoms may be any one or more of 3-methyl-1-hexyl group, 5-methyl-1-hexyl group, 1-heptyl group, and 1-hexyl group.

In the lubricant for the fluid dynamic bearing in the present invention, the base oil may be formed by adding at least one or more selected from other base oil, a sulfur-based extreme pressure agent, a rust preventive agent, an antioxidant, an acidic phosphate ester, and an amine-based neutralizer to the primary base oil.

In the lubricant for the fluid dynamic bearing in the present invention, the other base oil may contain at least one or more selected from a mineral oil-based base oil, a synthetic base oil, an ester oil, and a phosphate triester having saturated hydrocarbon groups of 6 to 9 carbon atoms, and a content of the primary base oil relative to the base oils may be from 30% by weight to less than 100% by weight.

In the lubricant for the fluid dynamic bearing in the present invention, the average number of carbon atoms of the three saturated hydrocarbon groups contained in the primary base oil may be more than 7 and less than 8.

In the lubricant for the fluid dynamic bearing in the present invention, the average number of carbon atoms of the saturated hydrocarbon groups of all phosphate triesters resulting from combining the phosphate triester in the form of the primary base oil with the phosphate triester contained in the other base oil may be more than 7 and less than 8.

In the lubricant for the fluid dynamic bearing in the present invention, all the saturated hydrocarbons contained in the primary base oil may be linear alkyl groups.

In the lubricant for the fluid dynamic bearing in the present invention, the saturated hydrocarbon groups having 8 to 9 carbon atoms contained in the primary base oil may be branched alkyl groups, and the saturated hydrocarbon groups having 6 to 7 carbon atoms contained in the primary base oil may be linear alkyl groups.

In the lubricant for the fluid dynamic bearing in the present invention, the saturated hydrocarbon groups having 8 to 9 carbon atoms contained in the primary base oil may be linear alkyl groups, and the saturated hydrocarbon groups having 6 to 7 carbon atoms contained in the primary base oil may be branched alkyl groups.

One aspect of a fluid dynamic bearing in the present invention is a fluid dynamic bearing having a shaft body, a shaft body support section in which a shaft body insertion hole is formed that houses the shaft body while allowing to rotate freely, the lubricant for the fluid dynamic bearing according to the present invention filled into a gap formed between the shaft body and the shaft body insertion hole, and a dynamic pressure generation section in which dynamic pressure generation grooves are formed in at least one or both of a surface of the shaft body and an inner wall surface of the shaft body insertion hole, the dynamic pressure generation grooves generating dynamic pressure by gathering the lubricant for the fluid dynamic bearing when the shaft body and the shaft body support section are relatively rotated around its axis, wherein further having an oil seal section which is formed on an end of the gap and gradually expands towards an opening of the shaft body insertion hole, and a ratio of a surface area of the opening (S mm²) to a volume of the oil seal section (V mm³) satisfies a relationship of 2≦S/V≦6 (1/mm).

According to the one aspect of the fluid dynamic bearing in this invention, since the lubricant having a low amount of evaporation is used, even when the opening surface area S is large relative to the oil seal section volume V, an increase in the amount of evaporation of the lubricant can be suppressed. Namely, a length of the oil seal section can be shortened by increasing the opening surface area S in the case in which the oil seal section volume V remains constant. In addition, in the case in which the opening surface area remains constant, the fluid dynamic bearing can be used for a long period of time even when the volume V is small and the amount of the lubricant filled into the oil seal section decreases.

In the case in which a ratio S/V of the opening surface area S to the volume V of the oil seal section is more than 6 (1/mm), the oil seal section no longer functions as a capillary seal and the lubricant ends up leaking easily from the gap to an outside. Consequently, the ratio S/V is made to be 6 (1/mm) or less. In the case in which the ratio S/V is less than 2, the length of the oil seal section becomes long, thereby making it difficult to reduce the size of the fluid dynamic bearing. Consequently, the ratio S/V is made to be 2 (1/mm) or more.

In the one aspect of the fluid dynamic bearing in the present invention, the surface area of the opening section may satisfy a relationship of 0.5≦S≦6 (mm²).

In the case in which the opening surface area S is more than 6 (mm²), the amount of evaporation of the lubricant may become large. Consequently, the opening surface area S may be 6 (mm²) or less. In the case in which the opening surface area S is less than 0.5 (mm²), the length of the oil seal section becomes long, which may make it difficult to reduce the size of the fluid dynamic bearing. Consequently, the opening surface area S may be 0.5 (mm²) or more.

Another aspect of a fluid dynamic bearing in this invention is a fluid dynamic bearing having a shaft body, a shaft body support section in which a shaft body insertion hole is formed that houses the shaft body while allowing to rotate freely, the lubricant for the fluid dynamic bearing filled into a gap formed between the shaft body and the shaft body insertion hole, and a dynamic pressure generation section in which dynamic pressure generation grooves are formed in at least one or both of a surface of the shaft body and an inner wall surface of the shaft body insertion hole, the dynamic pressure generation grooves generating dynamic pressure by gathering the lubricant for the fluid dynamic bearing when the shaft body and the shaft body support section are relatively rotated around its axis, wherein the shaft body and the shaft body support section are formed from same type of ferrous metal material.

According to the another aspect of the fluid dynamic bearing in this invention, a portion of the surface of the shaft body contacts an inner peripheral surface of the shaft body support section in a state in which the shaft body is stationary relative to the shaft body support section. Friction is then generated between the shaft body and the shaft body support section when the shaft body is rotated with respect to the shaft body support section from this stationary state. Since the lubricant is heated by a heat generated by this friction, together with the phosphate triester contained in the lubricant being degraded at a high temperature, it bonds with the iron components of the shaft body and the shaft body support section resulting in the formation of iron phosphates (FeP, Fe₃P, Fe₂P, and FeP₂). Together with this iron phosphate forming a smooth surface by entering indentations present in the surface of the shaft body and the inner wall surface of the sleeve, it also forms a coating having superior lubricity on the surface of the shaft body and the inner wall surface of the shaft body support section. The aforementioned indentations are formed due to the friction between the shaft body and shaft body support section.

Thus, even when local depletion of the oil film occurs in the gap between the shaft body and the shaft body support section, occurrence of galling in the fluid dynamic bearing can be inhibited and rotation lockup can be prevented by the aforementioned coating.

In addition, wear of the shaft body and the shaft body support section due to the aforementioned friction can be suppressed as a result of forming the shaft body and the shaft body support section from a same type of metal materials having equal hardness.

A motor in the present invention has a stator having a core and a coil, a rotor having a permanent magnet arranged in a shape of a ring in opposition to the stator, and the fluid dynamic bearing according to the present invention, wherein the stator and the shaft body support section are integrally fixed, and the rotor is fixed to the shaft body.

According to the motor in this invention, since the lubricant having low viscosity is used, when the rotor is rotated relative to the stator, the resistance of the lubricant decreases thereby making it possible to reduce a current consumption required for driving the rotor.

In addition, since a lubricant having a low viscosity temperature dependency is used, when the rotor is rotated relative to the stator, even when a temperature of the lubricant changes due to the friction between the shaft body and the shaft body support section, the amount of the change in its viscosity is low. Thus, the rotational accuracy of the rotor relative to the stator can be maintained because together with suppressing an increase in the motor current consumption accompanying an increase in viscosity of the lubricant at low temperatures, a decrease in bearing rigidity can be suppressed accompanying a decrease in viscosity of the lubricant at high temperatures.

An information recording and retrieval device in the present invention has the motor according to the present invention, an information recording medium in a form of a thin plate, and a head stack assembly that records information onto the information recording medium and retrieves information recorded on the information recording medium, wherein the rotor includes a fixing section that fixes the information recording medium.

According to the information recording and retrieval device in this invention, since the rotational accuracy of the rotor relative to the stator is improved, that is, since rotational unevenness of the motor is suppressed, the rotor rotates stably when the information recording medium is rotated by the motor. Consequently, failures can be prevented when recording information onto the information recording medium or retrieving information recorded on the information recording medium with the head stack assembly by rotating the rotor and the information recording medium.

### BRIEF DESCRIPTION OF THE DRAWINGS

FIG. 1 is a schematic cross-sectional view showing an HDD of an embodiment of this invention.

FIG. 2 is an enlarged cross-sectional view showing a fluid dynamic bearing in the HDD of FIG. 1.

FIG. 3 is an enlarged cross-sectional view showing an oil seal section in the HDD of FIG. 1.

FIG. 4 is an enlarged cross-sectional view showing an oil seal section in a fluid dynamic bearing of the prior art.

FIG. 5 is a graph showing an amount of evaporation of a lubricant used in an HDD of the present invention.

FIG. 6 is a graph showing a viscosity temperature dependency of a lubricant used in an HDD of the present invention.

FIG. 7 is a graph showing a current consumption required to drive a shaft body and a rotor in an HDD of the present invention.

### BEST MODE FOR CARRYING OUT THE INVENTION

The following provides an explanation of preferred embodiments of the present invention with reference to the drawings. However, the present invention is not limited by any of the following embodiments, and the constituent features of these embodiments may also be suitably combined.

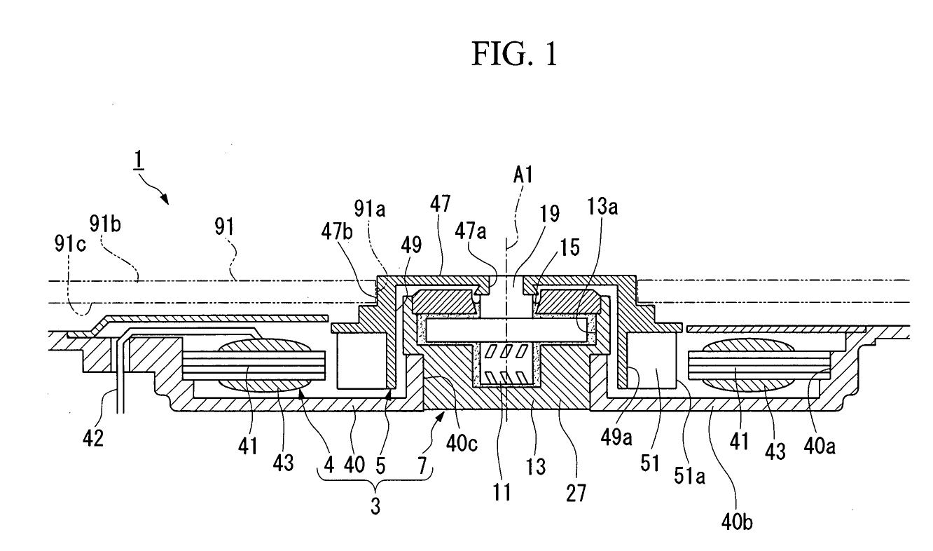

FIGS. 1 to 7 are drawings showing one embodiment of this invention. As shown in FIG. 1, a HDD (information recording and retrieval device) 1 of this embodiment includes a motor 3. This motor 3 includes a base plate 40 formed into a roughly short cylindrical shape, a stator 4 fixed to the base plate 40, a rotor 5 that rotates about central axis A1 relative to the stator 4, and a fluid dynamic bearing 7 that supports the rotor 5 so that the rotator 5 allows to rotate freely relative to the stator 4.

The fluid dynamic bearing 7 includes a shaft body 11 formed into a shape of a cylindrical column having a roughly cross-shaped vertical section, a sleeve (shaft body support section) 13 having a shaft body insertion hole 13a of which vertical section is roughly cross-shaped and which houses the shaft body 11 so that the shaft body 11 allows to rotate freely, and a lubricant (lubricant for a fluid dynamic bearing) 15 filled in a gap between the shaft body insertion hole 13a and the shaft body 11.

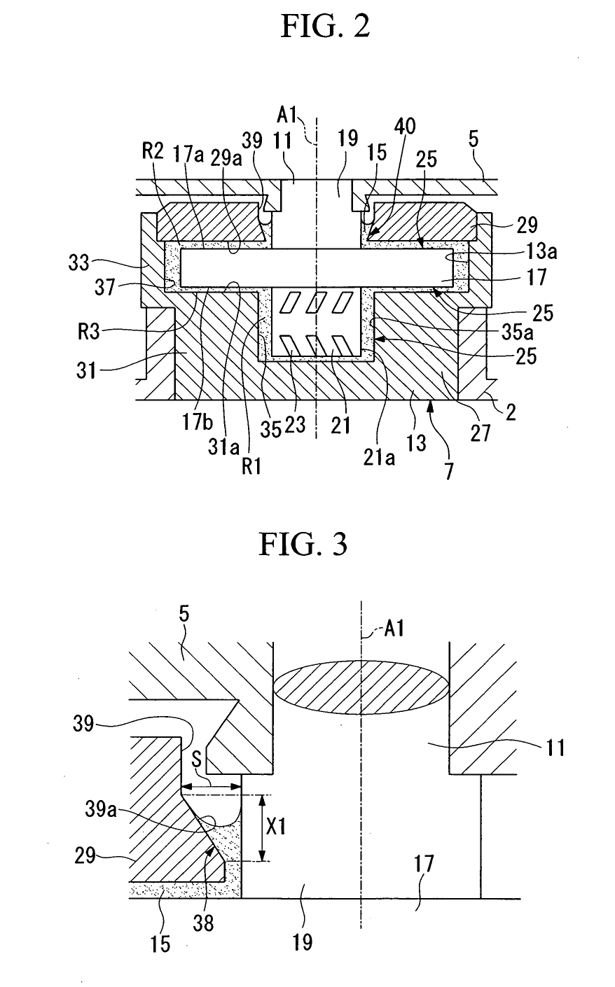

As shown in FIG. 2, the shaft body 11 includes a thrust shaft section 17 formed into a shape of a flange in a central section in a direction of the central axis Al, and a support section 19 and a radial shaft section 21 which are roughly cylindrical column-shaped and are protruding to both sides in the direction of the central axis A1, and the thrust shaft section 17, the support section 19, and the radial shaft section 21 are integrally formed.

A plurality of dynamic pressure generation grooves 23 arranged in a herringbone pattern are formed on an outer peripheral surface 21a of the radial shaft section 21. In addition, a plurality of dynamic pressure generation grooves arranged in a spiral pattern (not shown) are formed on a top surface 17a and a bottom surface 17b of the thrust shaft section 17.

These dynamic pressure generation grooves generate dynamic pressure by gathering lubricant 15 when the shaft body 11 is rotated around the central axis A1, and the dynamic pressure enables the shaft body 11 to be rotatably supported by the sleeve 13. Namely, a dynamic pressure (radial pressure) of the lubricant 15 generated in the dynamic pressure generation grooves 23 of the radial shaft section 21 fulfills a role of a bearing of the shaft body 11 in a radial direction. In addition, a dynamic pressure (thrust dynamic pressure) of the lubricant 15 generated in the dynamic pressure generation grooves of the thrust shaft section 17 fulfills a role of a bearing of the shaft body 11 in a direction of the central axis A1.

A dynamic pressure generation section 25 includes the lubricant 15 and the dynamic pressure generation grooves.

The sleeve 13 includes a sleeve body 27 having a roughly cylindrical shape with a bottom, and a counter plate 29 that forms a gap between itself and the shaft body 11 and covers an open end of the sleeve body 27 in a state in which the support section 19 of the shaft body 11 is made to protrude therefrom. The sleeve body 27 is fixed to a base member 2, and includes a small diameter cylindrical section 31 and a large diameter cylindrical section 33.

The small diameter cylindrical section 31 has a hole 35 that forms a closed end side of the shaft body insertion hole 13a, and the radial shaft section 21 can be inserted into this hole 35.

The large diameter cylindrical section 33 has a through hole 37 that forms an open end side of the shaft body insertion hole 13a, and the thrust shaft section 17 can be inserted into this through hole 37.

This small diameter cylindrical section 31 and this large diameter cylindrical section 33 are integrally formed.

The counter plate 29 is formed into a roughly disk-like shape, and a through hole 39 is formed for housing the support section 19 in the direction of its central axis A1. This through hole 39 includes the shaft body insertion hole 13a together with the through hole 35 of the small diameter cylindrical section 31 and the through hole 37 of the large diameter cylindrical section 33. In addition, as shown in FIG. 3, this through hole 39 has a corn-shaped tapered surface 39a that expands towards the rotor 5 along central axis A1.

A space which is interposed between this tapered surface 39a of the through hole 39 and an outer peripheral surface of the support section 19 opposite the tapered surface 39a and of which cross-section is roughly trapezoidal serves as an oil seal section 38 that prevents the leakage of the lubricant 15 from a gap between the shaft body 11 and the shaft body insertion hole 13a. Namely, the oil seal section 38 is formed at an end of the gap between the shaft body 11 and the shaft body insertion hole 13a, and is formed so as to gradually expand towards the opening of the shaft body insertion hole 13a.

When a volume of this oil seal section 38 is designated as V (mm³) and a surface area of the opening side of the oil seal section 38 is designated as S (mm²), a relationship between V and S is such that 2≦S/V≦6 (1/mm). In addition, the opening surface area S is such that 0.5≦S≦6 (mm²).

In the case in which the ratio S/V of the opening surface area S to the volume V of the oil seal section 38 is more than 6 (1/mm), the oil seal section 38 may no longer function as a capillary oil seal and the lubricant 15 may easily leak from the gap to an outside. Consequently, the S/V is set to be 6 (1/mm) or less. In the case in which the opening surface area S is more than 6 (mm²), the amount of evaporation of the lubricant 15 may become excessively large. Consequently, the opening surface area S is set to be 6 (mm²) or less. Moreover, in the case in which the S/V is less than 2, or in the case in which the opening surface area S is less than 0.5 (mm²), a length of the oil seal section 38 becomes long, as a result, it may be difficult to reduce a size of the fluid dynamic bearing 7. Consequently, the S/V is set to be 2 (1/mm) or more, and the opening surface area S is set to be 0.5 (mm²) or more.

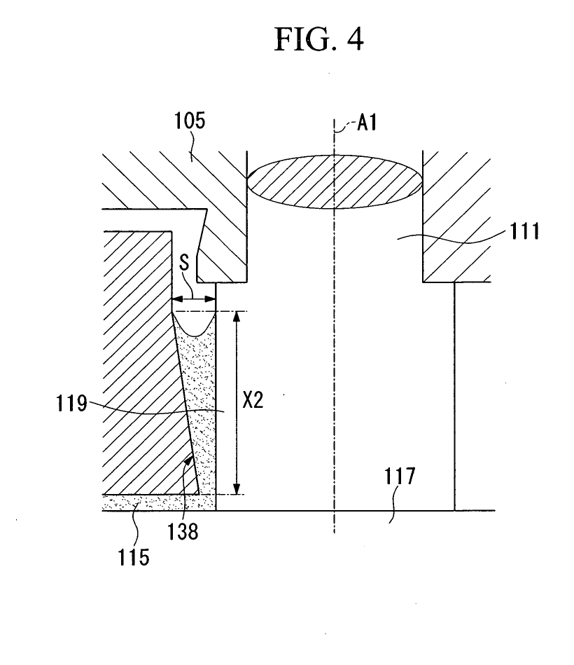

Here, in a fluid dynamic bearing of the prior art, since it was necessary to reduce the S for the purpose of suppressing the evaporation of the lubricant, the ratio of S to V was set to be smaller than the value of the S/V in the present embodiment, such as being set to be S/V=1.8 (1/mm). Consequently, as shown in FIG. 4, in an oil seal section 138 of the fluid dynamic bearing of the prior art, a length X2 in a direction of a central axis A1 is longer than a length X1 in the oil seal section 38 of the present embodiment. Namely, it is difficult to reduce the size of the fluid dynamic bearing.

Here, in FIG. 4, a reference symbol 105 indicates a rotor, a reference symbol 111 indicates a shaft body, a reference symbol 115 indicates a lubricant, a reference symbol 117 indicates a thrust shaft section, and reference symbol 119 indicates a support section of the shaft body 111.

In the fluid dynamic bearing 7 including in the manner described above, the radial dynamic pressure is generated as a result of the lubricant 15 being gathered in a gap R1 between an inner peripheral surface 35a of the hole 35 and the outer peripheral surface 21a of the radial shaft section 21 when the shaft body 11 is rotated relative to the sleeve 13. In addition, at this time, the thrust dynamic pressure is generated as a result of the lubricant 15 being gathered in a gap R2 between the top surface 17a of the thrust shaft section 17 and a bottom surface 29a of the counter plate 29 opposite the top surface 17a, and in a gap R3 between the bottom surface 17b of the thrust shaft section 17 and an end 31a in an axial direction of the small diameter cylindrical section 31 opposite the bottom surface 17b.

The shaft body 7 and the sleeve 13 included by this fluid dynamic bearing 7 are formed from a same type of ferrous metal material.

A phosphate triester represented by the following general formula (I) is contained in the lubricant 15 as a base oil of the lubricant composition.

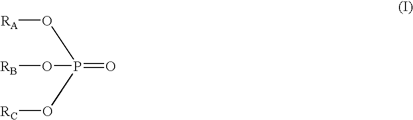

In the aforementioned general formula (I), R_{A}, R_{B}, and R_{C} respectively represent saturated hydrocarbon groups in the form of alkyl groups. The lubricant 15 contains as its primary base oil (to be referred to as a first base oil or a primary base oil), a phosphate triester in which the number of carbon atoms of one of the saturated hydrocarbon groups of R_{A} to R_{C} differs from the number of carbon atoms of the other two saturated hydrocarbon groups.

The phosphate triester as the first base oil (primary base oil) may have at least one saturated hydrocarbon group having 8 to 9 carbon atoms, and at least one saturated hydrocarbon group having 6 to 7 carbon atoms. Examples of the saturated hydrocarbon groups having 8 to 9 carbon atoms include 2-ethyl-1-hexyl group, 1-octyl group, 3,5,5-trimethyl-1-hexyl group, isononyl group, and 1-nonyl group. Examples of the saturated hydrocarbon groups having 6 to 7 carbon atoms include 3-methyl-1-hexyl group, 5-methyl-1-hexyl group, 1-heptyl group, and 1-hexyl group. Moreover, the average number of carbon atoms of the three saturated hydrocarbon groups of the phosphate triester as the first base oil is more than 7 and less than 8.

In the phosphate triester as the first base oil, the saturated hydrocarbon group having 8 to 9 carbon atoms may be a branched alkyl group, and the saturated hydrocarbon group having 6 to 7 carbon atoms may be a linear alkyl group.

However, without being limited to this, the saturated hydrocarbon groups that are included by the phosphate triester as the first base oil may all be linear alkyl groups or they may all be branched alkyl groups.

The base oil of the lubricant may also be obtained by adding (i) a second base oil (other base oil), (ii) a sulfur-based extreme pressure agent, (iii) a rust preventive agent, (iv) an antioxidant, (v) an acidic phosphate ester, a phosphite esters, or an acidic phosphite esters, or (vi) an amine-based neutralizer, and so forth to the first base oil as necessary.

Here, in the case of forming the base oil of the lubricant by adding the second base oil to the first base oil, a content of the first base oil with respect to the base oil may be 30% by weight or more and less than 100% by weight. In addition, in this case, the average number of carbon atoms of the saturated hydrocarbon groups of all phosphate triesters resulting from combining the phosphate ester serving as the first base oil and the phosphate triester contained in the second base oil may be more than 7 and less than 8.

(i) A second base oil is an oil of which the dynamic viscosity at 40° C. is preferably 2 to 4600 (mm²/s), more preferably 2 to 460 (mm²/s), and most preferably 2 to 220 (mm²/s), and there are no particular restrictions on types of the second base oil.

Namely, the second base oil may be that which is used as a base oil of an ordinary equipment oil, and may be a mineral oil or a synthetic oil.

Examples of mineral oil-based base oils include refined oils obtained by subjecting a paraffin-based crude oil, an intermediate-based crude oil, or a naphthene-based crude oil to a normal pressure distillation or a reduced pressure distillation, followed by subjecting lubricant distillates to refining methods such as a solvent deasphalting, a hydrocracking, a solvent dewaxing, a contact dewaxing, a hydrotreating, a sulfuric acid washing, and a clay treatment, and a primary hydrogenation-based oil or a secondary hydrogenation-based oil which is subjected to the hydrotreating, or a solvent refining-based oil is preferable, and among them, a highly refined mineral oil of the secondary hydrogenation-based oil is particularly preferable.

Examples of synthetic oil-based base oil include poly α-olefins, polybutenes, dibasic acid esters, polyalkylene glycols, hindered esters, aromatic tricarboxylic esters, alkyl benzenes, alkyl naphthalenes, and polyethers, and various synthetic oils can be used, however, among these, poly α-olefins are preferable.

The second base oil is an ester oil, and may be a phosphate triester in which the number of carbon atoms of each of R_{A}, R_{B}, and R_{C} in the general formula (I) is exactly equal. The triphosphate ester of the second base oil preferably has a saturated hydrocarbon group having 6 to 9 carbon atoms.

Examples of phosphate triesters of this second base oil include triaryl phosphates, trialkyl phosphates, trialkyl aryl phosphates, triaryl alkyl phosphates, and trialkenyl phosphates. Specific examples include triphenyl phosphate, tricresyl phosphate, benzyl diphenyl phosphate, ethyl diphenyl phosphate, tributyl phosphate, ethyl dibutyl phosphate, cresyl diphenyl phosphate, dicresyl phenyl phosphate, ethylphenyl diphenyl phosphate, diethylphenyl phenyl phosphate, propylphenyl diphenyl phosphate, dipropylphenyl phenyl phosphate, triethyl phenyl phosphate, tripropyl phenyl phosphate, butylphenyl diphenyl phosphate, dibutylphenyl phenyl phosphate, tributyl phenyl phosphate, trihexyl phosphate, triheptyl phosphate, tri(2-ethylhexyl) phosphate, trioctyl phosphate, trinonyl phosphate, tridecyl phosphate, trilauryl phosphate, trimyristyl phosphate, tripalmityl phosphate, tristearyl phosphate, and trioleyl phosphate.

Only one type of the aforementioned base oils may be used or two or more types may be used in combination.

(ii) As the sulfur-based extreme pressure agent, an agent which has a sulfur atom in its molecule and demonstrates extreme pressure properties and satisfactory wear characteristics, as well as being able to be dispersed in the lubricant base oil is used.

Examples of such agents include sulfurized fats and oils, sulfurized fatty acids, sulfurized esters, sulfurized olefins, dihydrocarvyl polysulfides, thiadiazole compounds, alkyl thiocarbamoyl compounds, thiocarbamate compounds, thioterpene compounds, and dialkyl thiodipropionate compounds.

The aforementioned sulfurized fats and oils are obtained by reacting sulfur, a sulfur-containing compound, and an oil (such as lard oil, whale oil, vegetable oil, or fish oil). Although there are no particular restrictions on a sulfur content of the sulfurized fats and oils, the sulfur content of 5 to 30% by weight is typically preferable.

Examples of these sulfurized fats and oils include sulfurized lard, sulfurized rapeseed oil, sulfurized castor oil, sulfurized soybean oil, and sulfurized rice bran oil.

Examples of the aforementioned sulfurized fatty acids include oleic methyl sulfide, while examples of the aforementioned sulfurized esters include oleic methyl sulfide and rice bran fatty acid octyl sulfide.

(iii) Examples of the rust preventive agents include metal sulfonates, carboxylic acids, alkanol amines, amides, acid amides, and phosphate ester metal salts, and among these, carboxylic acids are preferable. Examples of the metal deactivators include benzotriazole and thiadiazole, and among these, benzotriazole is preferable.

(iv) As the antioxidants, amine-based antioxidants and phenol-based antioxidants are preferably used.

Examples of the amine-based antioxidants include monoalkyl diphenyl amine-based antioxidants such as monooctyl diphenyl amine and monononyl diphenyl amine; dialkyl diphenyl amine-based antioxidants such as 4,4′-dibutyl diphenyl amine, 4,4′-dipentyl diphenyl amine, 4,4′-dihexyl diphenyl amine, 4,4′-diheptyl diphenyl amine, 4,4′-dioctyl diphenyl amine, and 4,4′-dinonyl diphenyl amine; polyalkyl diphenyl amine-based antioxidants such as tetrabutyl diphenyl amine, tetrahexyl diphenyl amine, tetraoctyl diphenyl amine, and tetranonyl diphenyl amine; and naphthyl amine-based antioxidants such as α-naphthyl amine, phenyl-α-naphthyl amine, butylphenyl-α-naphthyl amine, pentylphenyl-α-naphthyl amine, hexylphenyl-α-naphthyl amine, heptylphenyl-α-naphthyl amine, octylphenyl-α-naphthyl amine, and nonylphenyl-α-naphthyl amine. Among these, dialkyl phenyl amine-based antioxidants and naphthyl amine-based antioxidants are particularly preferable in terms of their antioxidatation life.

Examples of the phenol-based antioxidants include monophenol-based antioxidants such as 2,6-di-tert-butyl-4-methyl phenol, 2,6-di-tert-butyl-4-ethyl phenol, and 2,6-di- tert-butyl-4-{4,6-bis(octylthio)-1,3,5-triazine-2-ylamino} phenol; and diphenol-based antioxidants such as 4,4′-methylenebis(2,6-di-tert-butylphenol) and 2,2′-methylenebis (4-ethyl-6-tert-butylphenol).

Only one type of these antioxidants may be used, or two or more types may be used in combination. A range of the blended amount of these antioxidants with respect to a total weight of the lubricant for a fluid dynamic bearing is 0.01 to 5.0% by weight, and preferably 0.03 to 3.0% by weight,.

(v) Examples of the acidic phosphate esters include 2-ethylhexyl acid phosphate, ethyl acid phosphate, butyl acid phosphate, oleyl acid phosphate, tetracosyl acid phosphate, isodecyl acid phosphate, lauryl acid phosphate, tridecyl acid phosphate, stearyl acid phosphate, and isostearyl acid phosphate.

Examples of the phosphite esters include triethyl phosphite, tributyl phosphite, triphenyl phosphite, tricresyl phosphite, tri(nonylphenyl) phosphite, tri(2-ethylhexyl) phosphite, tridecyl phosphite, trilauryl phosphite, triisooctyl phosphite, diphenylisodecyl phosphate, tristearyl phosphite, and trioleyl phosphite.

Examples of the acidic phosphite esters include dibutyl hydrogen phosphite, dilauryl hydrogen phosphite, dioleyl hydrogen phosphite, distearyl hydrogen phosphite, and diphenyl hydrogen phosphite.

Among the aforementioned phosphate esters, tricresyl phosphate and triphenyl phosphate are preferable.

(vi) The amine-based neutralizer is a substance that forms an amine salt by neutralizing with the aforementioned phosphate esters. Examples of the amine-based neutralizers include mono-substituted amines, di-substituted amines, and tri-substituted amines represented by general formula (II).
R⁴ₙNH₃₋ₙ (II)

In this formula, R⁴ represents an alkyl group or alkenyl group having 3 to 30 carbon atoms, an aryl group or aryl alkyl group having 6 to 30 carbon atoms, or an hydroxyalkyl group having 2 to 30 carbon atoms, and n represents 1, 2, or 3. In the case of having a plurality of R⁴, the plurality of R⁴ may be the same or different. Here, among the R⁴ in the aforementioned general formula (II), the alkyl group or the alkenyl group having 3 to 30 carbon atoms may be a linear, branched, or cyclic group.

Examples of the mono-substituted amines include butyl amine, pentyl amine, hexyl amine, cyclohexyl amine, octyl amine, lauryl amine, stearyl amine, oleyl amine, and benzyl amine.

Examples of di-substituted amines include dibutyl amine, dipentyl amine, dihexyl amine, dicyclohexyl amine, dioctyl amine, dilauryl amine, distearyl amine, dioleyl amine, dibenzyl amine, stearyl monoethanol amine, decyl monoethanol amine, hexyl monopropanol amine, benzyl monoethanol amine, phenyl monoethanol amine, and tolyl monopropanol amine.

Examples of the tri-substituted amines include tributyl amine, tripentyl amine, trihexyl amine, tricyclohexyl amine, trioctyl amine, trilauryl amine, tristearyl amine, trioleyl amine, tribenzyl amine, dioleyl monoethanol amine, dilauryl monopropanol amine, dioctyl monoethanol amine, dihexyl monopropanol amine, dibutyl monopropanol amine, oleyl diethanol amine, stearyl dipropanol amine, lauryl diethanol amine, octyl dipropanol amine, butyl diethanol amine, benzyl diethanol amine, phenyl diethanol amine, tolyl dipropanol amine, xylyl diethanol amine, triethanol amine, and tripropanol amine.

The following provides an explanation of specific examples of a composition of the aforementioned lubricant 15.

### SPECIFIC EXAMPLE 1

Phosphate triesters in which the saturated hydrocarbon groups R_{A}, R_{B}, and R_{C} in the general formula (I) were 2-ethylhexyl groups having 8 carbon atoms and 1-heptyl group having 7 carbon atoms were used for a base oil P1 in lubricant compositions.

As shown in Table 1, a first base oil included a phosphate triester in which one of R_{A}, R_{B} and R_{C} was a 2-ethyl-1-hexyl group while other two were 1-heptyl groups, and the number of carbon atoms in each of R_{A}, R_{B}, and R_{C} was 8, 8, and 7, respectively, and a phosphate triester in which two of R_{A}, R_{B}, and R_{C} were 2-ethyl-1-hexyl groups while other one was a 1-heptyl group, and the number of carbon atoms in each of R_{A}, R_{B}, and R_{C} was 8, 7 and 7, respectively.

A second base oil included a phosphate triester in which all of R_{A}, R_{B}, and R_{C} were 1-heptyl groups, and a phosphate triester in which all of R_{A}, R_{B}, and R_{C} were 2-ethyl-1-hexyl groups.

The base oil P1 of the lubricant compositions included the first base oil and the second base oil at weight ratios shown in Table 1. When the weight ratio of each phosphate triester that composed the base oil P1 was taken to be the values shown in Table 1, the average number of carbon atoms of R_{A}, R_{B}, and R_{C} in this base oil P1 was 7.44.

TABLE 1

| | R_{A}, R_{B}, and R_{C} of | % by |
|---|---|---|
| | phosphate triesters | weight |
| First | One is a 2-ethyl-1-hexyl group, | 48 |
| base oil | and two are 1-heptyl groups | |
| | Two are 2-ethyl-1-hexyl groups, | 31 |
| | and one is a 1-heptyl group | |
| Second | All are 1-heptyl groups | 14 |
| base oil | All are 2-ethyl-1-hexyl groups | 7 |

As shown in Table 2, the lubricants of Specific Example 1 also included dioctyl amine (A1) as an amine-based neutralizer and 2,6-tert-butyl-4-methylphenol (B1) as an antioxidant, in addition to the base oil P1. In addition, these lubricants suitably included lauryl acid phosphate (Q1) as an acidic phosphate ester, benzotriazole (T1) as a rust preventive agent, and dihydrocarvyl polysulfide (S1) as a sulfur-based extreme pressure agent for improving extreme pressure properties and wear characteristics. Four types of lubricants L1 to L4 containing the base oil P1 were respectively composed using these components.

Here, values of specific gravity and viscosity shown in Table 2 were measured at 20° C.

TABLE 2

| | | Lubricant | | | |
|---|---|---|---|---|---|
| | | L1 | L2 | L3 | L4 |
| Blending | P1 | 95.3 | 92.8 | 92.4 | 98.8 |
| ratio | Q1 | 1 | 2 | 2 | — |
| (by parts) | A1 | 3 | 5 | 5 | 1 |
| | T1 | 0.1 | 0.1 | — | — |
| | S1 | 0.5 | — | 0.5 | — |
| | B1 | 0.1 | 0.1 | 0.1 | 0.2 |
| Lubricant | Specific gravity | 0.927 | 0.925 | 0.926 | 0.926 |
| character- | at 20° C. (kg/m³) | | | | |
| istics | Viscosity at | 12.35 | 12.60 | 12.80 | 12.25 |
| | 20° C. (mPa · s) | | | | |
| | Flash point (° C.) | 228 | 220 | 215 | 230 |

### SPECIFIC EXAMPLE 2

Phosphate triesters in which the saturated hydrocarbon groups R_{A}, R_{B}, and R_{C} in the general formula (I) were 1-octyl groups having 8 carbon atoms and 1-heptyl groups having 6 carbon atoms were used for base oils P2 to P4 in lubricant compositions.

As shown in Table 3, a first base oil includes a phosphate triester in which two of R_{A}, R_{B}, and R_{C} are 1-octyl groups while other one is a 1-hexyl group, and the number of carbon atoms in each of R_{A}, R_{B}, and R_{C} is 8, 8, and 6, respectively, and a phosphate triester in which one of R_{A}, R_{B}, and R_{C} is a 1-octyl group while other two are 1-hexyl groups, and the number of carbon atoms in each of R_{A}, R_{B}, and R_{C} is 8, 6, and 6, respectively.

A second base oil included a phosphate triester in which all of R_{A}, R_{B}, and R_{C} are 1-octyl groups and a phosphate triester in which all of R_{A}, R_{B}, and R_{C} are 1-hexyl groups.

The base oils P2 to P4 of the lubricant compositions contained the first base oil and the second base oil at weight ratios shown in Table 3. When the weight ratio of each type of phosphate triester that composes the base oils P2 to P4 is taken to be the values shown in Table 3, the average number of carbon atoms of R_{A}, R_{B}, and R_{C} in each base oil P2 to P4 was 7.42, 7.45, and 7.35, respectively.

TABLE 3

| | R_{A}, R_{B}, | P2 | P3 | P4 |
|---|---|---|---|---|
| | and R_{C} of | % by | % by | % by |
| | phosphate triester | weight | weight | weight |
| First | Two are 1-octyl | 62 | 59 | 58 |
| base oil | groups, and one | | | |
| | is a 1-hexyl group | | | |
| | One is a 1-octyl | 5 | 10 | 17 |
| | group, and two | | | |
| | are 1-hexyl groups | | | |
| Second | All are 1-octyl | 33 | 30 | 23 |
| base oil | groups | | | |
| | All are 1-hexyl | 0 | 1 | 2 |
| | groups | | | |

| | | | |
|---|---|---|---|
| Average number of carbon atoms | 7.42 | 7.45 | 7.35 |

As shown in Table 4, the lubricants of Specific Example 2 also included tricyclohexyl amine (A2) as an amine-based neutralizer and phenyl-α-naphthyl amine (B2) as an antioxidant, in addition to each base oil P2 to P4. In addition, these lubricants suitably included stearyl acid phosphate (Q2) as an acidic phosphate ester. Three types of lubricants L5 to L7 containing each base oil P2 to P4 were respectively composed using these components.

TABLE 4

| | | Lubricant | | |
|---|---|---|---|---|
| | | L5 | L6 | L7 |
| Blending | P2 | 96.9 | — | — |
| ratio | P3 | — | 96.4 | — |
| (by parts) | P4 | — | — | 96.9 |
| | Q2 | — | 0.5 | — |
| | A2 | 3.0 | 3.0 | 3.0 |
| | B2 | 0.1 | 0.1 | 0.1 |
| Lubricant | Specific gravity | 0.916 | 0.919 | 0.920 |
| character- | at 20° C. (kg/m³) | | | |
| istics | Viscosity at | 12.03 | 11.58 | 11.50 |
| | 20° C. (mPa · s) | | | |
| | Flash point (° C.) | 228 | 220 | 215 |

### SPECIFIC EXAMPLE 3

Phosphate triesters in which the saturated hydrocarbon groups R_{A}, R_{B}, and R_{C} in the general formula (I) were organic groups having 6 to 9 carbon atoms were used for base oils P8 to P11 in lubricant compositions.

As shown in Table 5, one of first base oils included a phosphate triester in which R_{A}, R_{B}, and R_{C} were 1-nonyl groups having 9 carbon atoms and 2-ethyl-1-butyl groups having 6 carbon atoms, and the average number of carbon atoms of R_{A}, R_{B}, and R_{C} was 7.35. Abase oil P8 was composed of only this first base oil.

Another of the first base oils included a phosphate triester in which R_{A}, R_{B}, and R_{C} were 1-octyl groups having 8 carbon atoms and 1-heptyl groups having 7 carbon atoms, and the average number of carbon atoms of R_{A}, R_{B}, and R_{C} was 7.67. A base oil P9 was composed of only this first base oil.

The other of the first base oils included a phosphate triester in which R_{A}, R_{B}, and R_{C} were isononyl groups having 8 carbon atoms and 1-heptyl groups having 7 carbon atoms, and the average number of carbon atoms of R_{A}, R_{B}, and R_{C} was 7.24. A base oil P10 was composed of only this first base oil.

TABLE 5

| | P8 | P9 | P10 |
|---|---|---|---|
| R_{A}, R_{B}, and R_{C} | 1-nonyl | 1-octyl | Isononyl |
| of phosphate ester | groups and | groups and | groups and |
| | 2-ethyl-1-butyl | 1-heptyl | 1-heptyl |
| | groups | groups | groups |
| Average number | 7.35 | 7.67 | 7.24 |
| of carbon atoms | | | |

As shown in Table 6, the lubricants of Specific Example 3 also included dioctyl monoethanol amine (A3) as an amine-based neutralizer and 2,6-di-tert-butyl-4-ethylphenol (B3) as an antioxidant, in addition to each base oil P8 to P10. In addition, these lubricants suitably included tri(2-ethylhexyl) phosphate (Q3) as an acidic phosphate ester. Three types of lubricants L8 to L10 containing each base oil P8 to P10 were respectively composed using these components.

TABLE 6

| | | Lubricant | | |
|---|---|---|---|---|
| | | L8 | L9 | L10 |
| Blending | P8 | 97.8 | — | — |
| ratio | P9 | — | 97.8 | — |
| (by parts) | P10 | — | — | 87.8 |
| | Q3 | — | — | 10 |
| | A3 | 2 | 2 | 2 |
| | B3 | 0.2 | 0.2 | 0.2 |
| Lubricant | Specific gravity | 0.910 | 0.926 | 0.916 |
| character- | at 20° C. (kg/m³) | | | |
| istics | Viscosity at | 13.14 | 12.76 | 13.55 |
| | 20° C. (mPa · s) | | | |
| | Flash point (° C.) | 242 | 230 | 245 |

As shown in FIG. 1, the stator 4 includes a plurality of cores 41 fixed to an inner peripheral surface 40a of the base plate 40 and the coil 43 wound around each core 41. A hole 40c centered about the central axis A1 is formed in a central section of a bottom wall section 40b of the base plate 40, and the aforementioned sleeve body 27 is fixed to this hole 40. Namely, the stator 4 and the sleeve 13 are integrally fixed by the base plate 40.

The coils 43 are electrically connected to a power supply not shown by a cable 42, and an alternating magnetic field is formed by these cores 41 and coils 43.

The rotor 5 is formed into a roughly cylindrical shape with a bottom. A through hole 47a centered about the central axis L1 is formed in a central section of a bottom wall section 47 of this rotor 5, and is fixed to the support section 19 of the shaft body 11. A permanent magnet 51 formed into a shape of a ring is fixed with an adhesive and so forth to an outer peripheral surface 49a of a cylindrical wall section 49 that protrudes from a peripheral edge of the bottom wall section 47 of the rotor 5.

As a permanent magnet 51, a neodymium magnet having a so-called radial anisotropy or an isotropy, in which a plurality of magnetic poles are arranged in a form of a ring and a direction of a magnetic flux of each of these magnetic poles roughly coincides with a direction of radial direction of the permanent magnet 51, is provided. This permanent magnet 51 is positioned so as to have a fixed gap between its outer peripheral surface 51a and the cores 41. Therefore, when the alternating magnetic field is generated by the cores 41 and the coils 43, this alternating magnetic field acts on the permanent magnet 51 resulting in rotation of the rotor 5 about central axis A1.

A ledge (fixing section) 47b for supporting a magnetic disk (information recording medium) 91 is formed on an outer periphery of the bottom wall section 47 of the rotor 5. The magnetic disk 91 can be rotated around the central axis A1 together with the rotor 5 and the shaft body 11 by engaging a central hole 91a formed in a center of the magnetic disk 91 with this ledge 47b.

This HDD (information recording and retrieval device) 1 includes a head stack assembly (HSA) fixed to the stator 4, and a magnetic head that moves between an outer peripheral edge and an inner peripheral edge of the magnetic disk 91 along a top surface and a bottom surface of the magnetic disk 91 is provided in this HSA. This magnetic head is made so as to be able to record information onto the magnetic disk 91 as well as retrieve information recorded on the magnetic disk 91.

The following provides an explanation of an amount of evaporation and a viscosity of the lubricant 15 used in the HDD 1 including in the manner described above.

As shown in Table 7, amounts of evaporation and viscosities were measured for three types of lubricants (Examples 1 to 3) that comply with the aforementioned conditions in the manner of Specific Examples 1 to 4 and two types of lubricants (Comparative Examples 1 and 2) used in the prior art.

TABLE 7

| | Average | Amount of | | |
|---|---|---|---|---|
| | number of | evaporation | Viscosity (mPa · s) | |
| | carbon atoms | (mg) | −5 (° C.) | 40 (° C.) |
| Example 1 | 7.44 | −36.6 | 37.80 | 7.28 |
| Example 2 | 7.45 | −36.0 | 38.00 | 7.28 |
| Example 3 | 7.67 | −40.5 | 39.90 | 7.48 |
| Comparative | 7.0 | −157.2 | 34.90 | 6.50 |
| Example 1 | | | | |
| Comparative | 9.0 | −17.4 | 72.00 | 12.50 |
| Example 2 | | | | |

Example 1 is a lubricant in which the lubricant L1 of the aforementioned Specific Example 1 was used. Here, the base oil of this lubricant was prepared so that the average number of carbon atoms of R_{A}, R_{B}, and R_{C} was 7.44. In Example 2, the lubricant L6 of the aforementioned Specific Example 2 was used, and the average number of carbon atoms of R_{A}, R_{B}, and R_{C} was 7.45. In Example 3, the lubricant L9 of the aforementioned Specific Example 3 was used, and the average number of carbon atoms of R_{A}, R_{B}, and R_{C} was 7.67.

Comparative Example 1 indicates a lubricant that contains tri-(1-heptyl) phosphate in which all the numbers of carbon atoms of R_{A}, R_{B}, and R_{C} were 7 as a base oil, and the average number of carbon atoms of R_{A}, R_{B}and R_{C} was 7.0 in the base oil of this lubricant. Comparative Example 2 indicates a lubricant that contains tri-(1-nonyl) phosphate in which all the number of carbon atoms of R_{A}, R_{B}, and R_{C} was 9 as a base oil, and the average number of carbon atoms of R_{A}, R_{B}, and R_{C} was 9.0 in the base oil of this lubricant.

The amounts of evaporation of each of the lubricants of Examples 1 to 3 and Comparative Examples 1 and 2 were determined by placing 3 ml of the lubricant in a Petri dish having a diameter of 27 mm held at a temperature of 80° C., weighing the lubricant after 720 hours and then calculating the amount of evaporation from a difference between this measured value and an initial value.

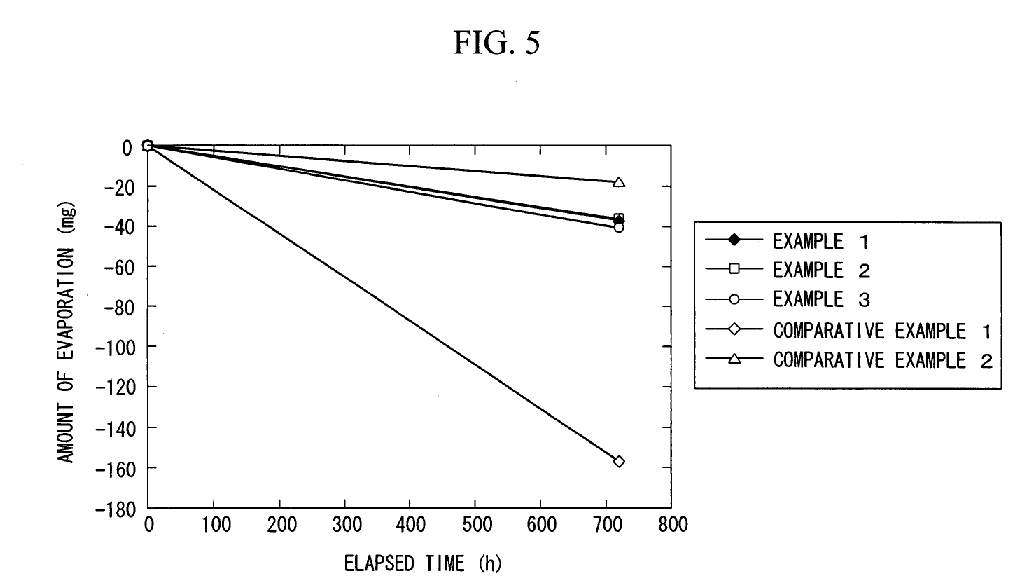

As shown in FIG. 5, all the amounts of evaporation for Examples 1 to 3 and Comparative Example 2 were within a range of 30 to 40 mg, and were satisfactory in being able to extend service life by about five years. In contrast, with respect to the lubricant of Comparative Example 1, a larger amount of the lubricant was determined to evaporate as compared with Examples 1 to 3.

On the basis of these findings, the use of the lubricants of Examples 1 to 3 makes it possible to reduce the amount of lubricant used in the motor 3. Namely, the volume of the gap between the shaft body 11 and the sleeve 13 in which the lubricant is injected can be decreased, thereby making it possible to reduce the size of the motor 3.

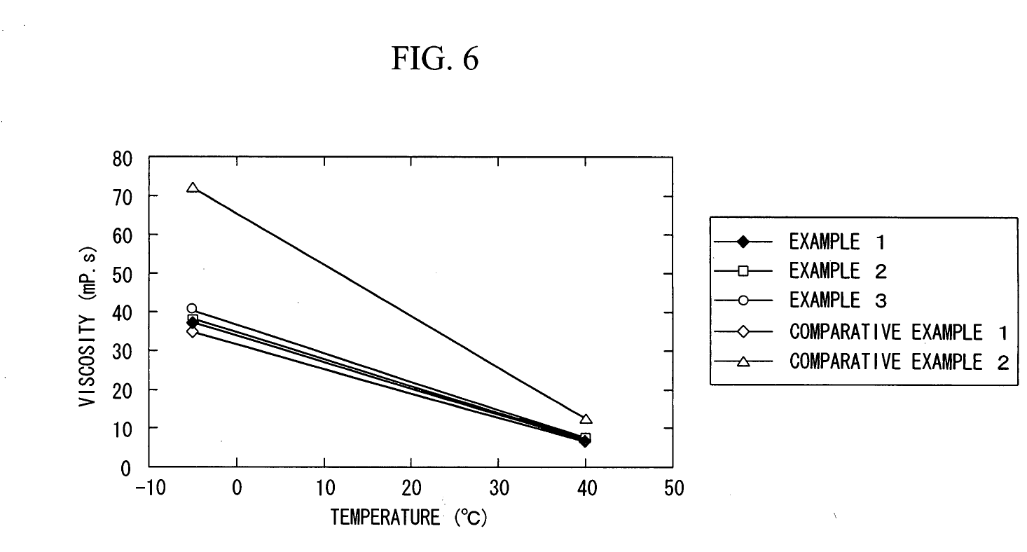

The viscosity of each of the lubricants of Examples 1 to 3 and Comparative Examples 1 and 2 were measured by setting a temperature of the lubricant to −5° C. and 40° C. As shown in FIG. 6, the viscosities tended to decrease with increasing temperature for all the lubricants. With respect to the lubricant of Comparative Example 2, viscosity was found to be higher than those of the lubricants of Examples 1 to 3 and Comparative Example 1 regardless of temperature. A change in the viscosity relative to a temperature change was smaller for the lubricants of Examples 1 to 3 and Comparative Example 1 than that for the lubricant of Comparative Example 2. Namely, this indicates a lower viscosity temperature dependency.

On the basis of the above, the lubricants of Examples 1 to 3 were able to reduce the tradeoff relationship between the amount of evaporation and the viscosity of the lubricants more than a lubricant for a fluid dynamic bearing (to also be referred to as a lubricant) of the prior art having, as their base oil, a phosphate triester in which the saturated hydrocarbon groups have the same numbers of carbon atoms. Therefore, a lubricant can be provided that has a small amount of evaporation, low viscosity, and low viscosity temperature dependency.

In the HDD 1 using the lubricant 15 having the aforementioned properties, the magnetic disk 91 is rotated in the case of recording information onto the magnetic disk 91 or retrieving information recorded on the magnetic disk 91. At this time, the alternating magnetic field is generated by the cores 41 and the coils 43, and this alternating magnetic field acts on the permanent magnet 51, thereby causing rotation of the rotor 5. As a result, the shaft body 11 rotates around the central axis A1, and the shaft body 11 and the rotor 5 are rotatably supported by the sleeve 13 due to the radial dynamic pressure and the thrust dynamic pressure generated in the dynamic pressure generation section 25.

In the case of using the lubricant 15 having low viscosity and low viscosity temperature dependency as described above, as well as being able to decrease a current consumption required for driving the rotor 5 when the rotor 5 is rotated relative to the stator 4, a rotational accuracy of the rotor 5 can also be improved.

While using the lubricant 15 of the present invention in the motor 3, and aging was carried out by repeatedly alternating between the state in which the current is allowed to flow to the coils 43 so that the rotor 5 rotates at a predetermined speed (ON state), and the state in which the current is not allowed to flow (OFF state) at five second intervals, a value of the current that flows to the coils 43 was measured every ten minutes. These current values represent a current consumption required for driving the shaft body 11 and the rotor 5.

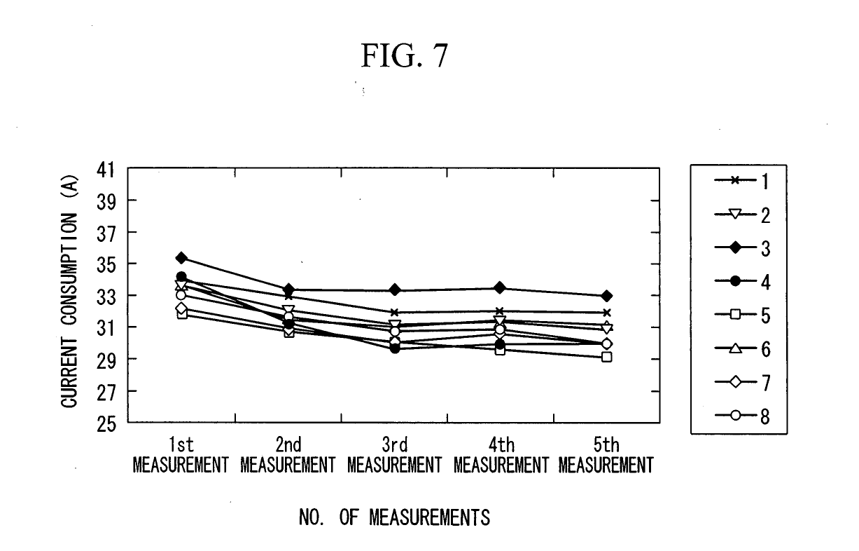

The measurement results are shown in FIG. 7. Here, the number of times the current values were measured is indicated on the horizontal axis, and the first time the current values were measured indicates the value obtained when the current was first supplied to the coils 43 following production of the motor 3. The measurements were made on a plurality of motors 3 by making available eight motors 3 of the same type and using the same lubricant 15.

According to these results, although there are differences in a value of the current consumption for each motor 3, the rotor 5 of each motor 3 can be seen to be driven at a nearly constant, low current consumption regardless of the passage of time. This result is attributable to the low viscosity of lubricant 15. Therefore, the use of lubricant 15 of the present invention makes it possible to drive the rotor 5 at low current consumption.

Although the lubricant 15 is heated due to a generation of a friction between the shaft body 11 and the sleeve 13 when the motor 3 is repeatedly started and stopped, the current values of each motor 3 can be seen to remain essentially unchanged. This result is attributable to the low viscosity temperature dependency of the lubricant 15. Therefore, as well as an increase of the current consumption of the motor 3 accompanying increases in the viscosity of the lubricant 15 at low temperatures being able to be suppressed, a decrease in a bearing rigidity accompanying decreases in the viscosity of the lubricant 15 at high temperatures are also suppressed, thereby the rotational accuracy of the rotor 5 with respect to the stator 4 can be maintained.

When the shaft body 11 is rotated relative to the sleeve 13 from the state in which it is stationary relative to the sleeve 13, the lubricant 15 is heated due to the friction between the shaft body 11 and the sleeve 13 as was previously stated. Consequently, as well as the phosphate triester contained in the lubricant 15 being degraded at high temperatures, iron phosphates (FeP, Fe₃P, Fe₂P, and FeP₂) are formed as a result of bonding with iron components of the shaft body 11 and the sleeve 13. As well as these iron phosphates forming a smooth surface by entering indentations present in the surface of the shaft body 11 and the inner wall surfaces of the sleeve 13, these iron phosphates form a coating having superior lubricity on the surface of the shaft body 11 and the inner wall surfaces of the sleeve 13. Here, the aforementioned indentations are formed due to the friction between the shaft body 11 and the sleeve 13.

As has been described above, as a result of incorporating the phosphate triester in which the saturated hydrocarbon groups has different numbers of carbon atoms in the lubricant 15, the lubricant 15 can be provided that has the small amount of evaporation, the low viscosity, and the low viscosity temperature dependency.

In the case of using this lubricant 15 in the fluid dynamic bearing, since the lubricant 15 which demonstrates the small amount of evaporation is used, increases in the amount of evaporation of the lubricant 15 can be suppressed even when the opening surface area S is increased relative to the volume V of the oil seal section 38. Namely, since, in the case in which the volume V of the oil seal section 38 is kept constant, the length of the oil seal section 38 can be shortened by increasing the opening surface area S more than in an oil seal section 38 of the prior art, the size and the thickness of the fluid dynamic bearing 7 can be reduced.

In the case in which the opening surface area S is kept constant, the fluid dynamic bearing 7 can be used for a long period of time even when the amount of the lubricant filled into the oil seal section 38 is reduced as a result of decreasing its volume V.

Moreover, since the coating including the iron phosphates is formed on the surface of the shaft body 11 and the inner wall surfaces of the sleeve 13, the occurrence of galling phenomena can be inhibited in the fluid dynamic bearing 7 even when localized oil film depletion occurs in the gap between the shaft body 11 and the sleeve 13, thereby preventing rotation lockup. In addition, since the shaft body 11 and the sleeve 13 are formed from the same types of metal materials having equal hardness, the wear of the shaft body 11 and the sleeve 13 caused by the aforementioned friction can be suppressed. These characteristics make it possible to prolong the service life of the fluid dynamic bearing.

In the case of providing this fluid dynamic bearing in the motor 3, since the lubricant 15 having the low viscosity and the low viscosity temperature dependency is used, the current consumption required to the drive rotor 5 can be reduced as well as the rotational accuracy of the rotor 5 with respect to stator 4 can be improved.

Moreover, in the case of providing this motor 3 in the HDD 1, since the rotational accuracy of the rotor 5 with respect to the stator 4 is improved, namely since rotational unevenness of the motor 3 can be suppressed, the occurrence of failures can be prevented when writing information onto the magnetic disk 91 or when reading information from the magnetic disk 91.

Here, although the stator 4 is arranged opposed to the outer peripheral surface 51a of the ring-shaped permanent magnet 51 in the aforementioned embodiment, the present invention is not limited to this, but rather is only required to be formed such that the rotor 5 is at least rotated by the stator 5 and the permanent magnet 51. Therefore, the stator 4 may also be arranged at a location opposite to the inner peripheral surface of the permanent magnet 51. In this case, the permanent magnet 51 should be fixed on the side of the inner peripheral surface of the rotor 5, and the stator 4 should be fixed on the base plate 40 opposed to this inner peripheral surface or the outer peripheral surface of the sleeve 13.

In addition, the present invention is not limited to the magnetic disk 91, but may also be, for example, an optical disk. In this case, instead of the magnetic head, an optical pickup should be provided in a HAS that records information onto an optical disk and retrieves information recorded on the optical disk.

While preferred embodiments of the invention have been described and illustrated above, the specific constitution of the present invention is not limited to these embodiments, but rather includes design changes and so forth within a range that does not depart from the spirit or scope of the present invention.

### INDUSTRIAL APPLICABILITY

The present invention is able to provide a lubricant having a small amount of evaporation, low viscosity and low viscosity temperature dependency as a result of containing a phosphate triester in which saturated hydrocarbon groups have different numbers of carbon atoms in the lubricant.

In addition, in the case of using this lubricant for a fluid dynamic bearing in a fluid dynamic bearing, a length of an oil seal section can be shortened by increasing an opening surface area S. In addition, since a volume V of the oil seal section can be decreased, a size and a thickness of the fluid dynamic bearing can be reduced. Also, in this case, since as well as preventing rotation lockup based on an occurrence of galling, wear of the shaft body and a bearing support section can be suppressed, service life of the fluid dynamic bearing can be prolonged.

Moreover, in the case of providing this fluid dynamic bearing in a motor, since a lubricant having low viscosity and low viscosity temperature dependency is used, as well as current consumption required for driving the rotor is reduced, rotational accuracy of the rotor relative to a stator is improved.

In the case of providing this motor in an information recording and retrieval device, since rotational unevenness of the motor is suppressed, an occurrence of failures can be prevented when writing information onto an information recording medium or reading information from the information recording medium.

1. A lubricant for a fluid dynamic bearing comprising a base oil containing a phosphate triester represented by a general formula (I) 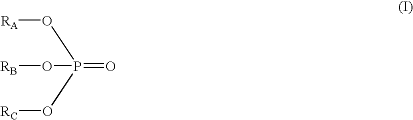
(wherein, R_{A}, R_{B}and R_{C} respectively represent alkyl groups),
wherein in the base oil, a phosphate triester in which the three alkyl groups in the general formula (I) are saturated hydrocarbon groups and number of carbon atoms of one of the three saturated hydrocarbon groups differs from number of carbon atoms of the other two saturated hydrocarbon groups is contained as a primary base oil.

2. A lubricant for a fluid dynamic bearing according to claim 1,
wherein the primary base oil has at least one saturated hydrocarbon group having 8 to 9 carbon atoms, and at least one saturated hydrocarbon group having 6 to 7 carbon atoms.

3. A lubricant for a fluid dynamic bearing according to claim 2, wherein the saturated hydrocarbon group having 8 to 9 carbon atoms is any one or more of 2-ethyl-1-hexyl group, 1-octyl group, 3,5,5-trimethyl-1-hexyl group, isononyl group, and 1-nonyl group.

4. A lubricant for a fluid dynamic bearing according to claim 2,
wherein the saturated hydrocarbon group having 6 to 7 carbon atoms is any one or more of 3-methyl-1-hexyl group, 5-methyl-1-hexyl group, 1-heptyl group, and 1-hexyl group.

5. A lubricant for a fluid dynamic bearing according to claim 1,
wherein the base oil is formed by adding at least one or more selected from other base oil, a sulfur-based extreme pressure agent, a rust preventive agent, an antioxidant, an acidic phosphate ester, and an amine-based neutralizer to the primary base oil.

6. A lubricant for a fluid dynamic bearing according to claim 5,
wherein the other base oil contains at least one or more selected from a mineral oil-based base oil, a synthetic base oil, an ester oil, and a phosphate triester having saturated hydrocarbon groups of 6 to 9 carbon atoms, and
a content of the primary base oil relative to the base oils is from 30% by weight to less than 100% by weight.

7. A lubricant for a fluid dynamic bearing according to claim 1,
wherein average number of carbon atoms of the three saturated hydrocarbon groups contained in the primary base oil is more than 7 and less than 8.

8. A lubricant for a fluid dynamic bearing according to claim 6,
wherein average number of carbon atoms of the saturated hydrocarbon groups of all phosphate triesters resulting from combining the phosphate triester in the form of the primary base oil with the phosphate triester contained in the other base oil is more than 7 and less than 8.

9. A lubricant for a fluid dynamic bearing according to claim 2,
wherein all the saturated hydrocarbons contained in the primary base oil are linear alkyl groups.

10. A lubricant for a fluid dynamic bearing according to claim 2,
wherein the saturated hydrocarbon groups having 8 to 9 carbon atoms contained in the primary base oil are branched alkyl groups, and
the saturated hydrocarbon groups having 6 to 7 carbon atoms contained in the primary base oil are linear alkyl groups.

11. A lubricant for a fluid dynamic bearing according to claim 2,
wherein the saturated hydrocarbon groups having 8 to 9 carbon atoms contained in the primary base oil are linear alkyl groups, and
the saturated hydrocarbon groups having 6 to 7 carbon atoms contained in the primary base oil are branched alkyl groups.

12. A fluid dynamic bearing comprising:
a shaft body;
a shaft body support section in which a shaft body insertion hole is formed that houses the shaft body while allowing to rotate freely;
the lubricant for the fluid dynamic bearing according to claim 1 filled into a gap formed between the shaft body and the shaft body insertion hole; and
a dynamic pressure generation section in which dynamic pressure generation grooves are formed in at least one or both of a surface of the shaft body and an inner wall surface of the shaft body insertion hole, the dynamic pressure generation grooves generating dynamic pressure by gathering the lubricant for the fluid dynamic bearing when the shaft body and the shaft body support section are relatively rotated around its axis,
wherein further comprising an oil seal section which is formed on an end of the gap and gradually expands towards an opening of the shaft body insertion hole, and
a ratio of a surface area of the opening (S mm²) to a volume of the oil seal section (V mm³) satisfies a relationship of 2≦S/V≦6 (1/mm).

13. A dynamic fluid bearing according to claim 12,
wherein the surface area of the opening section satisfies a relationship of 0.5≦S≦6 (mm²).

14. A fluid dynamic bearing comprising:
a shaft body;
a shaft body support section in which a shaft body insertion hole is formed that houses the shaft body while allowing to rotate freely;
the lubricant for the fluid dynamic bearing according to claim 1 filled into a gap formed between the shaft body and the shaft body insertion hole; and
a dynamic pressure generation section in which dynamic pressure generation grooves are formed in at least one or both of a surface of the shaft body and an inner wall surface of the shaft body insertion hole, the dynamic pressure generation grooves generating dynamic pressure by gathering the lubricant for the fluid dynamic bearing when the shaft body and the shaft body support section are relatively rotated around its axis,
wherein the shaft body and the shaft body support section are formed from a same type of ferrous metal material.

15. A motor comprising:
a stator having a core and a coil;
a rotor having a permanent magnet arranged in a shape of a ring in opposition to the stator; and
the fluid dynamic bearing according to claim 12,
wherein the stator and the shaft body support section are integrally fixed, and the rotor is fixed to the shaft body.

16. An information recording and retrieval device comprising:
the motor according to claim 15;
an information recording medium in a form of a thin plate; and
a head stack assembly that records information onto the information recording medium and retrieves information recorded on the information recording medium,
wherein the rotor comprises a fixing section that fixes the information recording medium.

17. A motor comprising:
a stator having a core and a coil;
a rotor having a permanent magnet arranged in a shape of a ring in opposition to the stator; and
the fluid dynamic bearing according to claim 14,
wherein the stator and the shaft body support section are integrally fixed, and
the rotor is fixed to the shaft body.

18. An information recording and retrieval device comprising:
the motor according to claim 17;
an information recording medium in a form of a thin plate; and
a head stack assembly that records information onto the information recording medium and retrieves information recorded on the information recording medium,
wherein the rotor comprises a fixing section that fixes the information recording medium.
